(19) United States
(12) Patent Application Publication
(10) Pub. No.: US 2010/0246893 A1
(43) Pub. Date: Sep. 30, 2010

(54) Method and Apparatus for Nonlinear Dynamic Estimation of Feature Depth Using Calibrated Moving Cameras

(76) Inventors: Ashwin Dani, Gainesville, FL (US); Khalid El-Rifai, Cairo (EG)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/495,588

(22) Filed: Jun. 30, 2009

Related U.S. Application Data
(63) Continuation-in-part of application No. 12/411,597, filed on Mar. 26, 2009.

(51) Int. Cl. G06K 9/00

(52) U.S. Cl. 382/106

(57) ABSTRACT

A method apparatus estimates depths of features observed in a sequence of images acquired of a scene by a moving camera by first locating features, estimating coordinates of the features and generating a sequence of perspective feature image. A set of differential equations are applied to the sequence of perspective feature images to form a nonlinear dynamic state estimator for the depths using only a vector of linear and angular velocities of the camera and the focal length of the camera. The camera can be mounted on a robot manipulator end effector. The velocity of the camera is determined by robot joint encoder measurements and known robot kinematics. An acceleration of the camera is obtained by differentiating the velocity and the acceleration is combined with other signals.

### RELATED APPLICATION

This Application is a continuation-in-part of U.S. application Ser. No. 12/411,597, “Method and Apparatus for Dynamic Estimation of Feature Depth Using Calibrated Moving Camera,” file by El Rifai et al. on Mar. 26, 2009, and incorporated herein by reference.

### FIELD OF THE INVENTION

This invention relates generally to computer vision, and more particularly to estimating depths of the features using 2D images.

### BACKGROUND OF THE INVENTION

In computer vision, the depth of features in images can be used for pose estimation and structure from motion applications. Usually, this is done with geometric models of an imaged object, or multiple images acquired by stereo cameras. Inherently, that leads to offline or static methods.

U.S. Pat. No. 6,847,728 describes a dynamic depth estimation method that uses multiple cameras.

U.S. Pat. No. 6,996,254 describes a method that uses a sequence of images and localized bundle adjustments conceptually similar to stereo methods.

U.S. Pat. No. 5,577,130 describes a depth estimation method for a single moving camera where a video camera is displaced to successive positions with a displacement distance that differs from each preceding position by a factor of two.

U.S. Pat. No. 5,511,153 describes using an extended Kalman filter with simplified dynamics with an identity system matrix for depth and motion estimation using video frames.

U.S. Pat. No. 6,535,114 B1 also uses extended Kalman filters along with detailed vehicle dynamical models to estimate structure from motion for a moving camera for this specific application.

Another method uses nonlinear state estimation and nonlinear observers, as opposed to extended Kalman filters, which are a linearization-based approximation. Approaches that use nonlinear observers include full state observers, which are generally desired but more difficult to design for stable convergence in this problem, De Luca et al., “On-Line Estimation of Feature Depth for Image-Based Visual Serving Schemes,” IEEE International Conference on Robotics and Automation, April 2007. Another method uses a reduced order observer and using sliding mode type of observers, Dixon, et al., “Range Identification for Perspective Vision Systems,” IEEE Transactions on Automatic Control, 48 (12), 2232-2238, 2003.

It is desired to estimate depth dynamically using a single moving camera, without the need for a geometric model of the imaged object. This means it is desired to have a sequence of estimated depth values each corresponding to a respective image frame.

### SUMMARY OF THE INVENTION

The embodiments of the invention provide a method and apparatus for nonlinear dynamic estimation of depths of features extracted from 2D images. The images are acquired by a camera moving with known velocity and having a known focal length. The nonlinear estimation method applies a set of differential equations to a sequence of perspective 2D images containing features. A nonlinear dynamic state estimator yields Euclidean depths of the features in the images using a velocity vector of the moving camera and the camera focal length.

In one embodiment, the camera is mounted on a robot manipulator end effector. The camera's velocity is determined by robot joint encoders' measurements and known robot kinematics.

In the Parent Application the estimator was a reduced order dynamic state estimator. In this application, a full order nonlinear dynamic state estimator is developed. This enables better estimation of rapidly varying depth values.

### BRIEF DESCRIPTION OF THE DRAWINGS

FIG. 1 is a block diagram of a method and apparatus for estimating depth of features in images acquired by a moving camera according to embodiments of the invention;

FIG. 2 is a block diagram of a method and apparatus for depth estimation using a robot manipulator mounted camera according to embodiments of the invention;

FIG. 3 is a graph comparing dynamic actual depth and estimated depth according to an embodiment of the invention; and

FIG. 4 is a graph comparing dynamic actual depth and real-time estimated depth according to an embodiment of the invention.

### DETAILED DESCRIPTION OF THE PREFERRED EMBODIMENT

Depth Estimation

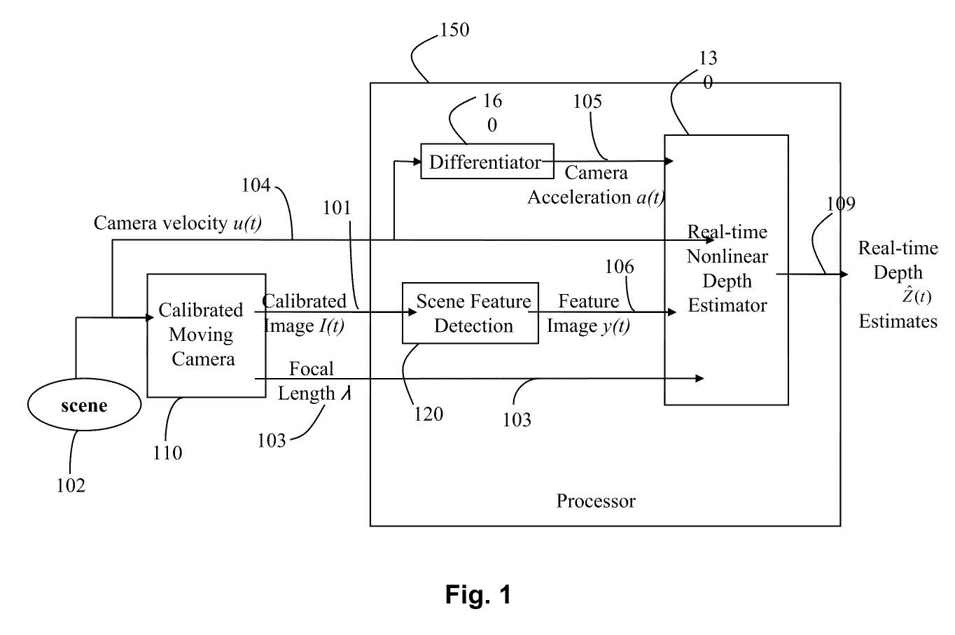

As shown in FIG. 1, a steps 120 and 130 of a method and apparatus 150 for determining depths 109 of features 106 in a sequence of calibrated images I(t) 101 acquired by a calibrated camera 110 of scene 102. The camera has a known focal length λ 103, and a known velocity vector u(t) 104, which can be differentiated 160 to determine an acceleration a(t) 105 for each time step t.

The method performs feature detection 120 to generate a sequence of feature images. The feature images are converted to perspective feature images y(t) 106 using a pin-hole camera model, which describes the relationship between the coordinates of the 3D features and their projections onto the images.

Real-time depth estimation 130 is applied to the perspective feature images to estimate the depths \hat{Z}(t) of the features. The steps are performed in a processor 150 as known in the art. The processor can include memories and I/O interfaces.

Robot Manipulated Camera

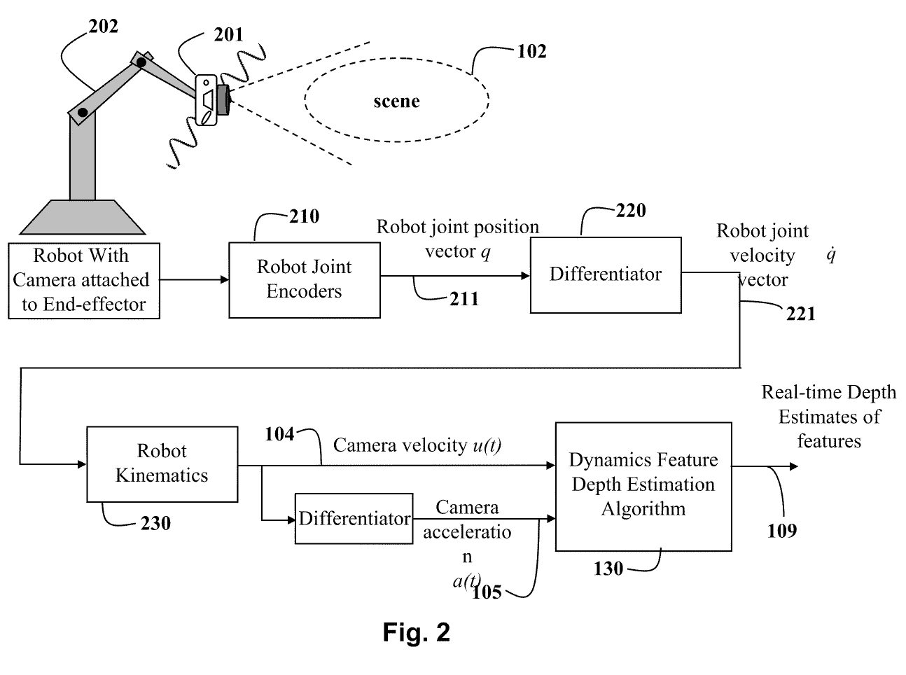

FIG. 2 shows one embodiment where a camera 201 is arranged on a robot manipulator 202. The robot manipulator is connected to robot joint encoders 210 to determine position vectors q 211. The camera velocity vector is

u(t)=J(q)\dot{q},

and the position vectors are differentiated to determine the corresponding robot joint velocity vectors \dot{q} 221, where J is Jacobian matrix known for the robot manipulator. The vectors q and \dot{q} are the robot joint angles and angular velocities. The vectors q and \dot{q} are obtained through robot joint sensing means, e.g., the encoder 210, and the filtered differentiation means 220, respectively.

Robot kinematics 230 estimate the camera velocity vector u(t) 104 and camera acceleration vector a(t) 105, which are used by the depth estimation 130 to estimate the depths 109 of the features.

This embodiment can be used for robot manipulator motion planning, fault detection and diagnostics, or for image based visual servo control.

Feature Velocities

For a fixed 3D feature at estimated coordinates (X, Y, Z) in the sequence of images acquired by the moving camera, the apparent velocity of the feature as observed in the images is

$$[ \begin{matrix}\dot{X} \\ \dot{Y} \\ \dot{Z}\end{matrix} ] = [ \begin{matrix}1 & 0 & 0 & 0 & {}^{C} Z & - {}^{C} Y \\ 0 & 1 & 0 & - {}^{C} Z & 0 & {}^{C} X \\ 0 & 0 & 1 & {}^{C} Y & - {}^{C} X & 0\end{matrix} ] u \qquad ( 1 )$$

where “\dot{}” above the variables indicate a first time derivative, u 104 is the 6D vector (u₁, u₂, u₃, u₄, u₅, u₆) of linear and the angular velocities of the camera.

Perspective Feature Images

Each camera image I(t) 101 can be converted to the perspective feature image y(t) 105 using the pin-hole model by

$${y}_{1} = λ \frac{X}{Z} \\ {y}_{2} = λ \frac{Y}{Z} . \qquad ( 2 )$$

Feature Dynamics

The above Equations can be rearranged to determine dynamics of the features by taking the first derivative as

$$[ \begin{matrix}{\dot{y}}_{1} \\ {\dot{y}}_{2}\end{matrix} ] = [ \begin{matrix}\frac{λ}{Z} & 0 & \frac{- {y}_{1}}{Z} & \frac{- {y}_{1} {y}_{2}}{λ} & ( λ + \frac{{y}_{1}^{2}}{λ} ) & - {y}_{2} \\ 0 & \frac{λ}{Z} & \frac{- {y}_{2}}{Z} & - ( λ + \frac{{y}_{2}^{2}}{λ} ) & \frac{{y}_{1} {y}_{2}}{λ} & {y}_{1}\end{matrix} ] u . \qquad ( 3 )$$

A nonlinear observer for the depth estimation Z is described below.

Differential Equations

A state is defined as

$$x ( t ) = {[ {y}_{1} {y}_{2} \frac{1}{Z} ]}^{T} .$$

Using Equations (1) and (3), the state dynamics are given by

$$\dot{x} = [ \begin{matrix}λ {x}_{3} & 0 & - {x}_{1} {x}_{3} & - \frac{{x}_{1} {x}_{2}}{λ} & ( λ + \frac{{x}_{1}^{2}}{λ} ) & - {x}_{2} \\ 0 & λ {x}_{3} & - {x}_{2} {x}_{3} & - ( λ + \frac{{x}_{2}^{2}}{λ} ) & \frac{{x}_{1} {x}_{2}}{λ} & {x}_{1} \\ 0 & 0 & - {x}_{3}^{2} & - \frac{{x}_{2} {x}_{3}}{λ} & \frac{{x}_{1} {x}_{3}}{λ} & 0\end{matrix} ] u \\ y = [ \begin{matrix}{x}_{1} \\ {x}_{2}\end{matrix} ] . \qquad ( 4 )$$

where y(t) is the output.

Depth Estimators

In one embodiment the nonlinear state estimator \hat{x}(t) for the state x(t) is given by

\hat{x}= x̅+γ, (5)

where the signals x̅(t) and y(t) are given by

$$\begin{matrix}\dot{\overline{x}} = [ \begin{matrix}λ {\hat{x}}_{3} & 0 & - {y}_{1} {\hat{x}}_{3} & - \frac{{y}_{1} {y}_{2}}{λ} & ( λ + \frac{{y}_{1}^{2}}{λ} ) & - {y}_{2} \\ 0 & λ {\hat{x}}_{3} & - {y}_{2} {\hat{x}}_{3} & - ( λ + \frac{{y}_{2}^{2}}{λ} ) & \frac{{y}_{1} {y}_{2}}{λ} & {y}_{1} \\ 0 & 0 & - {\hat{x}}_{3}^{2} & - \frac{{y}_{2} {\hat{x}}_{3}}{λ} & \frac{{y}_{1} {\hat{x}}_{3}}{λ} & 0\end{matrix} ] u + [ \begin{matrix}{k}_{1} {e}_{1} \\ {k}_{2} {e}_{2} \\ {h}_{1} {e}_{1} + {h}_{2} {e}_{2} + {g}_{1} \frac{{h}_{1} {k}_{1} {e}_{1} + {h}_{2} {k}_{2} {e}_{2}}{{h}_{1}^{2} + {h}_{2}^{2}}\end{matrix} ] & ( 6 ) \\ γ = [ \begin{matrix}0 \\ 0 \\ {f}_{1} ( t ) {e}_{1} ( t ) - {f}_{1} ( {t}_{0} ) {e}_{1} ( {t}_{0} ) - {\int }_{{t}_{0}}^{t} ( \frac{\begin{matrix}{\dot{g}}_{1} {h}_{1} + \\ {g}_{1} {\dot{h}}_{1}\end{matrix}}{{h}_{1}^{2} + {h}_{2}^{2}} - \frac{2 {g}_{1} {h}_{1} ( \begin{matrix}{h}_{1} {\dot{h}}_{1} + \\ {h}_{2} {\dot{h}}_{2}\end{matrix} )}{{( {h}_{1}^{2} + {h}_{2}^{2} )}^{2}} ) {e}_{1} \\ + {f}_{2} ( t ) {e}_{2} ( t ) - {f}_{2} ( {t}_{0} ) {e}_{2} ( {t}_{0} ) - {\int }_{{t}_{0}}^{t} ( \frac{\begin{matrix}{\dot{g}}_{1} {h}_{2} + \\ {g}_{1} {\dot{h}}_{2}\end{matrix}}{{h}_{1}^{2} + {h}_{2}^{2}} - \frac{2 {g}_{1} {h}_{2} ( \begin{matrix}{h}_{1} {\dot{h}}_{1} + \\ {h}_{2} {\dot{h}}_{2}\end{matrix} )}{{( {h}_{1}^{2} + {h}_{2}^{2} )}^{2}} ) {e}_{2}\end{matrix} ] \\ {\hat{x}}_{3} ( {t}^{+} ) = cM sgn ( {\hat{x}}_{3} ( t ) ) if \vert {\hat{x}}_{3} ( t ) \vert \geq M and τ > ε & ( 7 )\end{matrix}$$

In Equation (7), a resetting law is given, where \hat{x}₃(t⁺) is a state after reset, M is a positive constant, 0<c<1, τ is time between two consecutive resets and ε is pre-defined threshold.

The terms e₁(t) and e₂(t) are the measurable error terms given by

e₁=x₁−\hat{x}₁

e₂=x₂−\hat{x}₂. (8)

The measurable functions h₁(t). h₂(t), f₁(t), f₂(t), g₁(t) are given by

$${h}_{1} = ( λ {u}_{1} - {y}_{1} {u}_{3} ) , \\ {h}_{2} = ( λ {u}_{2} - {y}_{2} {u}_{3} ) , \\ {g}_{1} = ( \frac{{y}_{1} {u}_{5} - {y}_{2} {u}_{4}}{λ} + {k}_{3} ) \\ {f}_{1} = {g}_{1} \frac{{h}_{1}}{{h}_{1}^{2} + {h}_{2}^{2}} \\ {f}_{2} = {g}_{1} \frac{{h}_{2}}{{h}_{1}^{2} + {h}_{2}^{2}} . \qquad ( 9 )$$

The terms k₁, k₂ and k₃(t) are gains of an estimator and are greater than zero with the gain condition

k₃(t)>max(x₃(t))u₃(t)+\hat{x}₃(t) u₃(t) for all t.

In another embodiment, the estimator \hat{x}(t) for the state x(t) is given by

\hat{x}= x̅+γ, (10)

where the signals x̅(t) and y(t) are given by

$$\begin{matrix}\dot{\overline{x}} = [ \begin{matrix}λ {\hat{x}}_{3} & 0 & - {y}_{1} {\hat{x}}_{3} & - \frac{{y}_{1} {y}_{2}}{λ} & ( λ + \frac{{y}_{1}^{2}}{λ} ) & - {y}_{2} \\ 0 & λ {\hat{x}}_{3} & - {y}_{2} {\hat{x}}_{3} & - ( λ + \frac{{y}_{2}^{2}}{λ} ) & \frac{{y}_{1} {y}_{2}}{λ} & {y}_{1} \\ 0 & 0 & - {\hat{x}}_{3}^{2} & - \frac{{y}_{2} {\hat{x}}_{3}}{λ} & \frac{{y}_{1} {\hat{x}}_{3}}{λ} & 0\end{matrix} ] u + [ \begin{matrix}{k}_{1} {e}_{1} \\ {k}_{2} {e}_{2} \\ \frac{{h}_{1} {e}_{1}}{P} + \frac{{h}_{2} {e}_{2}}{P} + g \frac{{h}_{1} {k}_{1} {e}_{1} + {h}_{2} {k}_{2} {e}_{2}}{{h}_{1}^{2} + {h}_{2}^{2}}\end{matrix} ] ; & ( 11 ) \\ γ = [ \begin{matrix}0 \\ 0 \\ {f}_{1} ( t ) {e}_{1} ( t ) - {f}_{1} ( {t}_{0} ) {e}_{1} ( {t}_{0} ) - {\int }_{{t}_{0}}^{t} ( \frac{\begin{matrix}\dot{g} {h}_{1} + \\ g {\dot{h}}_{1}\end{matrix}}{{h}_{1}^{2} + {h}_{2}^{2}} - \frac{2 {gh}_{1} ( \begin{matrix}{h}_{1} {\dot{h}}_{1} + \\ {h}_{2} {\dot{h}}_{2}\end{matrix} )}{{( {h}_{1}^{2} + {h}_{2}^{2} )}^{2}} ) {e}_{1} \\ + {f}_{2} ( t ) {e}_{2} ( t ) - {f}_{2} ( {t}_{0} ) {e}_{2} ( {t}_{0} ) - {\int }_{{t}_{0}}^{t} ( \frac{\begin{matrix}\dot{g} {h}_{2} + \\ g {\dot{h}}_{2}\end{matrix}}{{h}_{1}^{2} + {h}_{2}^{2}} - \frac{2 {gh}_{2} ( \begin{matrix}{h}_{1} {\dot{h}}_{1} + \\ {h}_{2} {\dot{h}}_{2}\end{matrix} )}{{( {h}_{1}^{2} + {h}_{2}^{2} )}^{2}} ) {e}_{2}\end{matrix} ] \\ {\hat{x}}_{3} ( {t}^{+} ) = - cM if {\hat{x}}_{3} ( t ) < - M and τ > ε . & ( 12 )\end{matrix}$$

In Equation (12), a resetting law is given, where \hat{x}₃(t⁺) is a state after reset, M is a positive constant, 0<c<1, τ is time between two consecutive resets and ε is pre-defined threshold.

The terms e₁(t) and e₂(t) are error terms defined in Equation (7). The functions h₁(t), h₂(t), f₁(t), f₂(t) , g₁(t) are given by Equation (9). The function P(t) is defined as

$$P ( t ) = {e}^{{\int }_{{t}_{0}}^{t} 2 {\hat{x}}_{3} {u}_{3} d t} . \qquad ( 13 )$$

The gains k₁, k₂ and k₃ of the estimator are greater than zero with the gain condition k₃(t)>max(x₃(t))u₃(t).

For both embodiments, the estimated depth is \hat{Z}=1/\hat{x}₃.

Comparing Actual and Estimated Depths

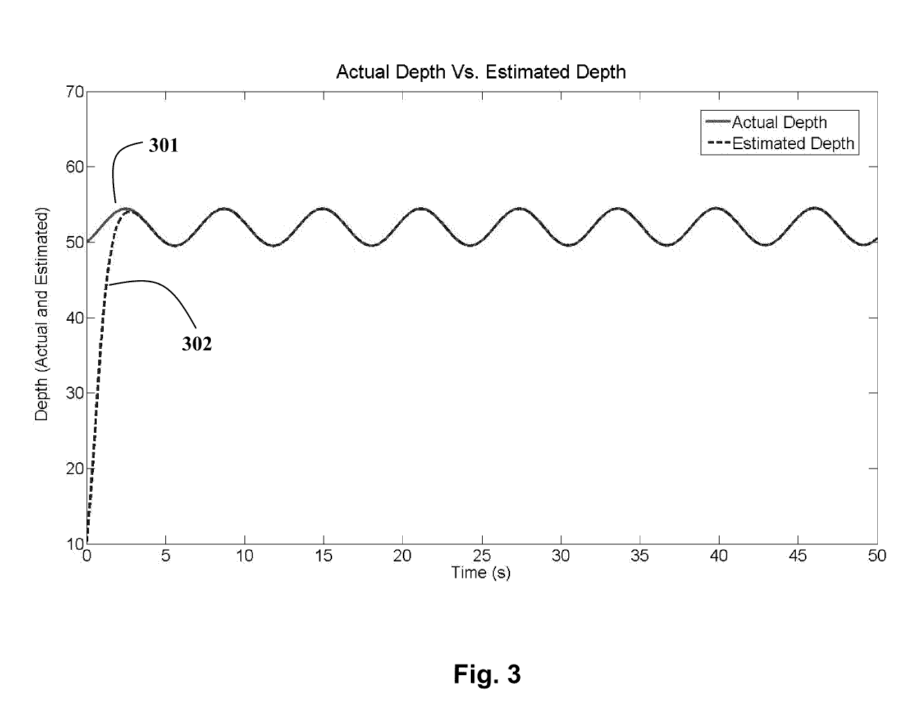

FIG. 3 compares the actual depth 301 and the estimated depth 302. The velocity vector is u=[−0.001 t, 0, 0.5cos(t), 0.1, 0.1, 1]^{T}, and the an initial position of (X, Y, Z)=(10, 20, 50) using a first embodiment of the estimator. As can be seen the estimate converges to the actual depth after about four seconds.

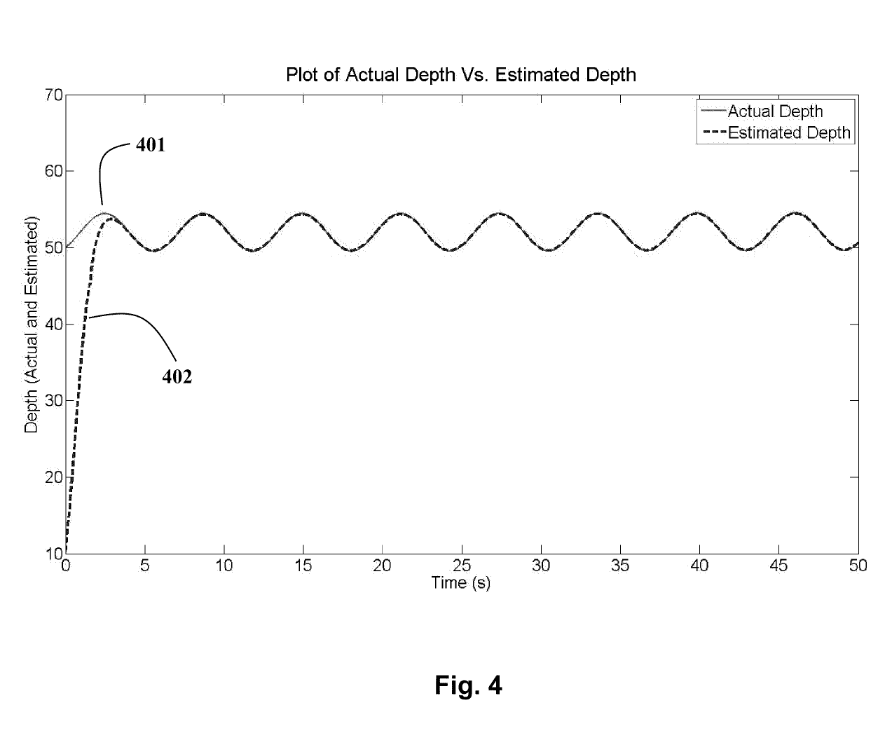

FIG. 4 compares the actual depths 401 and estimated depths 402 for a velocity vector u=[−0.001 t, 0, 0.5cos(t), 0.1, 0.1, 1]^{T}, and an initial position of (X, Y, Z)=(10, 20, 50) using second embodiment of the estimator. The estimator takes about four seconds to converge to the real depth.

From FIGS. 3 and 4 it can be seen that the both the embodiments of the estimators are able to identify/estimate dynamically varying depth quickly and accurately.

The Parent Application uses a reduced order dynamic state estimator. In this Application, we use a full order nonlinear dynamic state estimator. This enables better estimation of rapidly varying depth values, compare the FIG. 3 of the Parent Application, and FIG. 3 of the current Application.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for estimating depths of features observed in a sequence of images acquired of a scene, comprising a processor for performing steps of the method, comprising the steps:
estimating coordinates of the features in the sequence of images I(t), wherein the sequence of images is acquired by a camera moving at a known velocity u(t) with respect to the scene;
generating a sequence of perspective feature image y(t) from the features; and
applying a set of differential equations to the sequence of perspective feature image y(t) to form a nonlinear dynamic state estimator for the depths of the features using only a velocity vector u(t)=(u₁, u₂, u₃, u₄, u₅, u₆) of linear and angular velocities of the camera, and a camera focal length λ.

2. The method of claim 1, wherein each feature at coordinates (X, Y, Z) has a velocity
$$[ \begin{matrix}\dot{X} \\ \dot{Y} \\ \dot{Z}\end{matrix} ] = [ \begin{matrix}- 1 & 0 & 0 & 0 & - Z & Y \\ 0 & - 1 & 0 & Z & 0 & - X \\ 0 & 0 & - 1 & - Y & X & 0\end{matrix} ] u ( t ) ,$$
where “\dot{}” above variables indicate a first derivative, Z is a depth of the feature.

3. The method of claim 2, further comprising:
converting each image I to a perspective image by
$${y}_{1} = λ \frac{X}{Z}$$
$${y}_{2} = λ \frac{Y}{Z} .$$

4. The method of claim 3, wherein an estimator \hat{x} of the state x is \hat{x}= x̅γy,
$$\dot{\overline{x}} = [ \begin{matrix}λ {\hat{x}}_{3} & 0 & - {y}_{1} {\hat{x}}_{3} & - \frac{{y}_{1} {y}_{2}}{λ} & ( λ + \frac{{y}_{1}^{2}}{λ} ) & - {y}_{2} \\ 0 & λ {\hat{x}}_{3} & - {y}_{2} {\hat{x}}_{3} & - ( λ + \frac{{y}_{2}^{2}}{λ} ) & \frac{{y}_{1} {y}_{2}}{λ} & {y}_{1} \\ 0 & 0 & - {\hat{x}}_{3}^{2} & - \frac{{y}_{2} {\hat{x}}_{3}}{λ} & \frac{{y}_{1} {\hat{x}}_{3}}{λ} & 0\end{matrix} ] u + [ \begin{matrix}{k}_{1} {e}_{1} \\ {k}_{2} {e}_{2} \\ {h}_{1} {e}_{1} + {h}_{2} {e}_{2} + g \frac{{h}_{1} {k}_{1} {e}_{1} + {h}_{2} {k}_{2} {e}_{2}}{{h}_{1}^{2} + {h}_{2}^{2}}\end{matrix} ]$$
$$γ = [ \begin{matrix}0 \\ 0 \\ {f}_{1} ( t ) {e}_{1} ( t ) - {f}_{1} ( {t}_{0} ) {e}_{1} ( {t}_{0} ) - {\int }_{{t}_{0}}^{t} ( \frac{\begin{matrix}{\dot{g}}_{1} {h}_{1} + \\ {g}_{1} {\dot{h}}_{1}\end{matrix}}{{h}_{1}^{2} + {h}_{2}^{2}} - \frac{2 {g}_{1} {h}_{1} ( \begin{matrix}{h}_{1} {\dot{h}}_{1} + \\ {h}_{2} {\dot{h}}_{2}\end{matrix} )}{{( {h}_{1}^{2} + {h}_{2}^{2} )}^{2}} ) {e}_{1} \\ + {f}_{2} ( t ) {e}_{2} ( t ) - {f}_{2} ( {t}_{0} ) {e}_{2} ( {t}_{0} ) - {\int }_{{t}_{0}}^{t} ( \frac{\begin{matrix}{\dot{g}}_{1} {h}_{2} + \\ {g}_{1} {\dot{h}}_{2}\end{matrix}}{{h}_{1}^{2} + {h}_{2}^{2}} - \frac{2 {g}_{1} {h}_{2} ( \begin{matrix}{h}_{1} {\dot{h}}_{1} + \\ {h}_{2} {\dot{h}}_{2}\end{matrix} )}{{( {h}_{1}^{2} + {h}_{2}^{2} )}^{2}} ) {e}_{2}\end{matrix} ]$$
$${\hat{x}}_{3} ( {t}^{+} ) = cM sgn ( {\hat{x}}_{3} ( t ) ) if \vert {\hat{x}}_{3} ( t ) \vert \geq M and τ > ε$$
where “̂” above variables indicates an estimate. A resetting law \hat{x}₃(t⁺)=cx₃(t) is used where \hat{x}₃(t⁺) is a state after reset, M is a positive constant, 0<c<1, τ is time between two consecutive resets and ε is pre-defined threshold.
The gain k₃ is positive which holds the inequality k₃(t)>max(x₃(t))u₃(t)+\hat{x}₃(t)u₃(t) for all t. A a-priori known upper bound of x₃(t) is used to calculate k₃. The terms e₁(t), e₂(t), g₁(t), h₁(t)), h₂(t) f₁(t), f₂(t) are introduced in (7) and (8). The estimated depth is \hat{Z}=1/\hat{x}₃.

5. The method of claim 3, wherein an estimator \hat{x} of the state x is \hat{x}= x̅+γ,
$$\dot{\overline{x}} = [ \begin{matrix}λ {\hat{x}}_{3} & 0 & - {y}_{1} {\hat{x}}_{3} & - \frac{{y}_{1} {y}_{2}}{λ} & ( λ + \frac{{y}_{1}^{2}}{λ} ) & - {y}_{2} \\ 0 & λ {\hat{x}}_{3} & - {y}_{2} {\hat{x}}_{3} & - ( λ + \frac{{y}_{2}^{2}}{λ} ) & \frac{{y}_{1} {y}_{2}}{λ} & {y}_{1} \\ 0 & 0 & - {\hat{x}}_{3}^{2} & - \frac{{y}_{2} {\hat{x}}_{3}}{λ} & \frac{{y}_{1} {\hat{x}}_{3}}{λ} & 0\end{matrix} ] u + [ \begin{matrix}{k}_{1} {e}_{1} \\ {k}_{2} {e}_{2} \\ \frac{{h}_{1} {e}_{1}}{P} + \frac{{h}_{2} {e}_{2}}{P} + g \frac{{h}_{1} {k}_{1} {e}_{1} + {h}_{2} {k}_{2} {e}_{2}}{{h}_{1}^{2} + {h}_{2}^{2}}\end{matrix} ] ;$$
$$γ = [ \begin{matrix}0 \\ 0 \\ {f}_{1} ( t ) {e}_{1} ( t ) - {f}_{1} ( {t}_{0} ) {e}_{1} ( {t}_{0} ) - {\int }_{{t}_{0}}^{t} ( \frac{\begin{matrix}{\dot{g}}_{1} {h}_{1} + \\ {g}_{1} {\dot{h}}_{1}\end{matrix}}{{h}_{1}^{2} + {h}_{2}^{2}} - \frac{2 {g}_{1} {h}_{1} ( \begin{matrix}{h}_{1} {\dot{h}}_{1} + \\ {h}_{2} {\dot{h}}_{2}\end{matrix} )}{{( {h}_{1}^{2} + {h}_{2}^{2} )}^{2}} ) {e}_{1} \\ + {f}_{2} ( t ) {e}_{2} ( t ) - {f}_{2} ( {t}_{0} ) {e}_{2} ( {t}_{0} ) - {\int }_{{t}_{0}}^{t} ( \frac{\begin{matrix}{\dot{g}}_{1} {h}_{2} + \\ {g}_{1} {\dot{h}}_{2}\end{matrix}}{{h}_{1}^{2} + {h}_{2}^{2}} - \frac{2 {g}_{1} {h}_{2} ( \begin{matrix}{h}_{1} {\dot{h}}_{1} + \\ {h}_{2} {\dot{h}}_{2}\end{matrix} )}{{( {h}_{1}^{2} + {h}_{2}^{2} )}^{2}} ) {e}_{2}\end{matrix} ]$$
$${\hat{x}}_{3} ( {t}^{+} ) = - cM if {\hat{x}}_{3} ( t ) < - M and τ > ∈$$
where “̂” above variables indicates an estimate. A resetting law \hat{x}₃(t⁺)=cx₃(t) is used where \hat{x}₃(t⁺) is a state after reset, M is a positive constant, and 0<c<1, τ is time between two consecutive resets and ε is pre-defined threshold. The gain k₃ is positive which holds the inequality k₃(t)>max(x₃(t))u₃(t). A a-priori known upper bound of x₃(t) is used to calculate k₃. The terms e₁(t), e₂(t), g₁(t), h₁(t), h₂ (t), f₁(t), f₂(t) are introduced in (7) and (8) and the term P(t) is defined in (10). The estimated depth is \hat{Z}=1/\hat{x}₃.

6. The method of claim 1, wherein the camera is arranged on a robot manipulator end effector and the velocity of the camera is determined from robot joint measurements.

7. The method of claim 6, further comprising:
determining position vectors q from the robot joint measurements;
differentiating the position vectors q to obtain joint velocity vectors \dot{q}, and wherein the velocity is
u(t)=J(q)\dot{q},
wherein J(q) is a Jacobian matrix known for robot manipulator kinematics;
differentiating the camera velocity vector and combining it along with other signals as shown in (6) and (9).

8. A processor for estimating depths of features observed in a sequence of images acquired of a scene, comprising:
means for estimating coordinates of the features in a sequence of perspective images y(t), y(t) generated from an input images I(t) acquired by a camera moving at a known velocity u(t); and
means for applying a set of differential equations to the sequence of perspective image y(t) to form a nonlinear dynamic state estimator for the depths of the features using a velocity vector u(t)=(u₁, u₂, u₃, u₄, u₅, u₆) of linear and angular velocities of the camera, and a camera focal length λ.

9. The processor of claim 8, further comprising:
a robot manipulator configured to move the camera;
joint encoders configured to determine positions of the robot manipulator joints; and
means for differentiating the position to obtain velocities of the robot joints; known robot kinematics are used along with joint positions and velocities to obtain camera velocity and means for differentiating camera velocity to obtain camera acceleration.
